(19) United States
(12) Patent Application Publication
(10) Pub. No.: US 2012/0323708 A1
(43) Pub. Date: Dec. 20, 2012

(54) Web-based Application and Mobile Application for Purchasing and Redeeming Lottery Tickets

(76) Inventors: Yorgos D. Marinakis, Rio Rancho, NM (US); Michael A. Martinez, Albuquerque, NM (US)

(21) Appl. No.: 13/162,476

(22) Filed: Jun. 16, 2011

(51) Int. Cl. G06Q 30/00

(52) U.S. Cl. 705/16

(57) ABSTRACT

A user interface for purchasing and redeeming lottery tickets, implemented through either a web-based application or a mobile application, where the application either resides on or communicates with a point of sale system on a lottery vendors server, and the lottery vendors server has no writable communication with the lottery facility where the winning numbers are determined and where lottery monies are held. The user interface also has several features that facilitate the automatic play of lottery games, and it can also be used to implement scratch-off type lottery games.

### CROSS-REFERENCE TO RELATED APPLICATIONS

Not applicable.

### STATEMENTS REGARDING FEDERALLY SPONSORED RESEARCH AND DEVELOPMENT

Not applicable.

### BACKGROUND

The embodiments of the present invention satisfy the needs of having web-based application and mobile application for purchasing and redeeming lottery tickets.

Information relevant to attempts to address these problems can be found in U.S. Patent Application No.'s 20100325009; 20110047135; which are not admitted to be prior art with respect to the present invention by its mention in this Background Section. However, it is desirable to have a better device than is disclosed in the references.

A lottery game can be implemented using any combination of n-from-m numbers where n<m, or using any combination of n-from-m and p-from-q numbers, where n<m and p<q. The numbers can be selected by the purchaser, or preprinted but concealed under scratch-off skins.

The method of U.S. patent application 20100325009, “Internet and mobile technologies based secured lottery system and method” by Rajan, Subbian and Tanniru, relates to purchasing (playing) a lottery game on a mobile phone. It relies on biometrics to authenticate a purchaser. Such a method requires the purchaser to visit a lottery agency at least once to provide their biometrics data to the agency, and it requires the addition of a biometrics-reading device and/or application to the purchaser's mobile device. The present invention in contrast can authenticate using a bank card or a credit card, or an Internet-based age verification system, which facilitates gaming nationally and internationally because a remote purchaser can play without first traveling to a remote lottery agency to supply biometrics in person. The method of U.S. patent application 20100325009 also relies on an architecture that allows the purchaser to communicate directly with a lottery server, which server is apparently a game server in which the games are lotteries and keno. This game server apparently determines winning ticket numbers as well as provides the games. Such architecture opens the lottery server to hacking. The present invention in contrast has no writeable link between the purchaser and the facility where winning lottery numbers are determined or where accounts may be held, thereby absolutely avoiding hacking incidents such as those that recently (April-June 2011) occurred with the Sony PlayStation Network. The present invention does not involve the use of gaming servers. It does not require state and multistate and national lotteries to start operating through gaming servers. It does not change the way state and multistate and national lotteries run their games, that is, how they each select winning numbers at one central lottery facility. Rather the present invention adds the functionality of being able to buy and redeem lottery tickets either through a web-based application or through a mobile application. This functionality requires the addition of an electronic point of sale (ePOS) infrastructure that can be accessed by the Internet and by mobile device links such as radio and microwave. The ePOS infrastructure comprises in part databases that are populated with winning lottery numbers and with purchased lottery numbers, POS applications, and user interfaces with applications. Any ePOS infrastructure implicitly requires interfaces with payment systems, both for accepting payments and for distributing winnings to purchasers.

U.S. patent application 20110047135, “Mobile application for monitoring and reporting lab results” by Vizethann and Burks, relates to a mobile application for monitoring and reporting laboratory data. It is a mobile phone application that reads a laboratory database.

### SUMMARY

The embodiments of the present invention are directed to an apparatus that satisfies the needs set out in the Background section.

The embodiments of the present invention comprise a user interface for purchasing and redeeming lottery tickets, implemented through either a web-based application or a mobile application, where the application either resides on or communicates with a point of sale system on a lottery vendors server, and the lottery vendors server has no writable communication with the lottery facility where the winning numbers are determined and where lottery monies are held. The user interface also has several features that facilitate the automatic play of lottery games, and it can also be used to implement scratch-off type lottery games.

As disclosed but not claimed in U.S. patent application 20100325009, the present applications can register purchased ticket numbers in the purchasers device memory, and automatically notify the winner of his wins. Optionally the applications also enable the automatic deposit of the winnings into an account, which can be the purchasers bank account, his credit card, an account with the lottery vendor, or another account.

### SOME FURTHER ADVANTAGES OF THE EMBODIMENTS OF THE INVENTION

The embodiments of the present invention offer further advantages than available in the relevant art. The embodiments of the present invention enable the purchaser to purchase a lottery ticket or tickets automatically at a date and time certain, and/or on a scheduled basis. For example, he can choose to purchase ten tickets next Wednesday at 3:00 pm, or he can choose to purchase tickets every Wednesday at 4:00 pm and every Saturday at 4:00 pm. Optionally he can require the application to prompt him at those times regarding whether he wants to perform the particular transaction. In these automatic and/or scheduled purchases, the purchaser can specify the numbers to be bought, or he can specify that random numbers are chosen, or a combination thereof. He can use the applications to implement a system or schedule of numbers to be played, or he can select to follow a pre-loaded system, or both, or neither. He can program the application to alert him when the lottery facility has reported that the jackpot has reached a certain amount. He can select to have his winnings deposited to or distributed amongst any number of accounts.

The present applications can also be used to implement scratch-off lottery games, wherein the numbers in the display are covered with electronic skins that can be virtually scratched off.

The user interfaces and the vendor applications presented here do not communicate with the lottery facility. The purchasers web browser or their mobile applications communicate with a lottery vendors computers, which vendor communicates with lottery databases in a way that does not allow the vendor to access the lottery facility. The databases in effect serve as a firewall between the lottery facility and the world. This configuration provides the benefit of preventing the lottery facility from being hacked through the web-based software applications or the mobile applications.

The ability to remotely purchase and redeem lottery tickets facilitates participation in the game, and helps to increase ticket sales.

The embodiments of the invention also have the benefit of being usable in person like a paper ticket. The ticket number and associated bar code can be displayed on the display screen of the mobile device. The bar code can be scanned at a retail store where the paper tickets are sold and redeemed, just like the bar code on the paper ticket can be scanned. The same system that processes and redeems the paper ticket can be used to process and redeem the electronic ticket. This saves the cost of the paper ticket and the associated infrastructure, and also preserves the excitement that accompanies the experience of in-person redemption of a winning ticket.

These and other advantages will become apparent as the embodiments of the invention are used.

### DRAWINGS

These and other features, aspects and advantages of the embodiments of the device and/or methods will become better understood with reference to the following description, appended claim and accompanying drawings where:

FIG. 1 shows a schematic of a web browser-based embodiment of the invention.

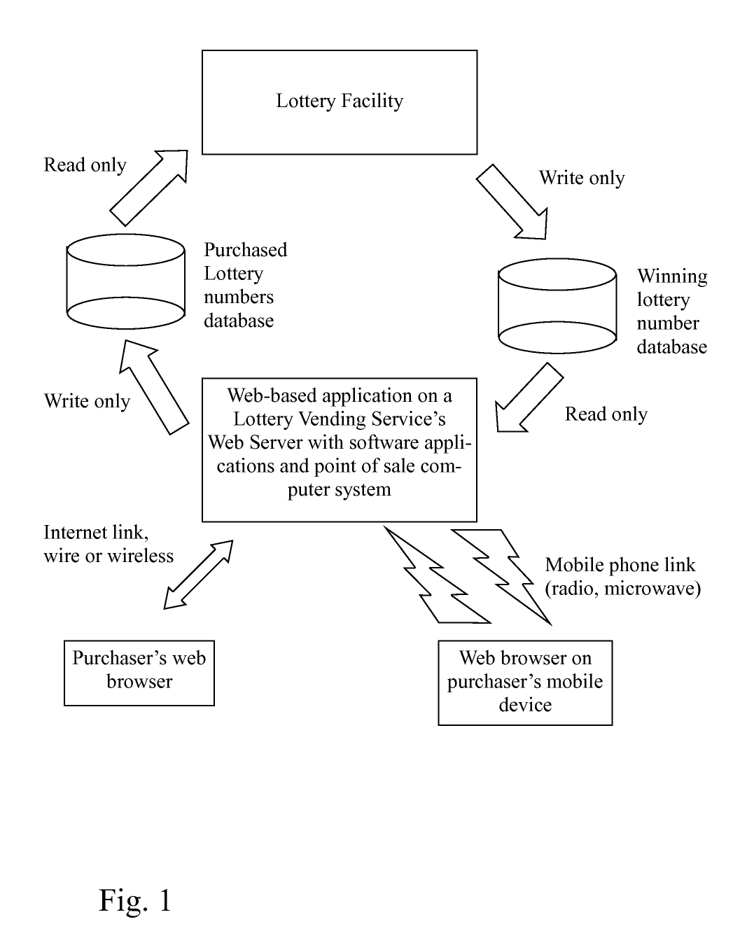

FIG. 2 shows a schematic of mobile application-based embodiment of the invention.

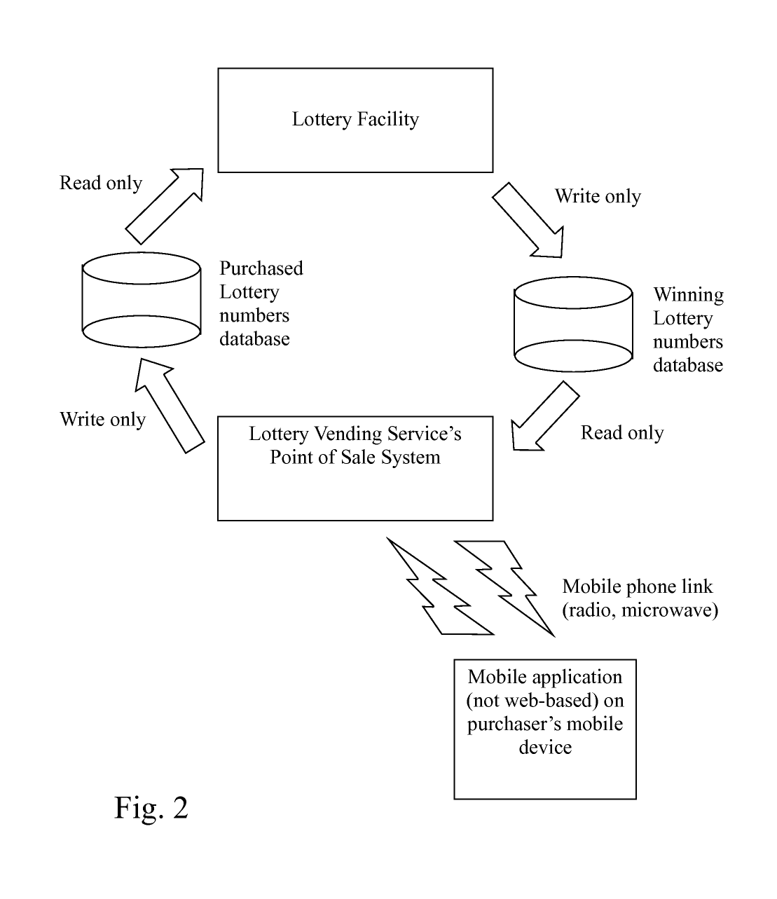

### DESCRIPTION

### Definitions

A web-based software application is a software package that can be accessed through a web browser. The software, and any accompanying databases, resides on a central server rather than being installed on the desktop system and is accessed over a network.

A mobile device is computing device that is small enough to be comfortably portable. It includes but is not limited to a cellular phone, a smartphone, a notebook computer, a netbook computer, or a personal digital assistant.

A smartphone is a mobile phone that offers advanced computing ability and connectivity.

A lottery vending service provider is a vender of lottery tickets. These venders also redeem winning lottery tickets, under certain conditions such as under certain amounts.

A lottery facility is the facility where the winning lottery numbers are determined and where accounts may be held.

A mobile phone link is a radio link, typically relayed by microwave towers.

A firewall is a device or an architecture or a software application designed to permit or deny network transmissions based upon a set of rules.

A point of sale system is where a transaction occurs. In the embodiments of the present invention, the web-based software applications may perform some or none of the functions of a point of sale system. Rather, the applications may perform non-sales functions such as logging purchased ticket numbers, and comparing purchased ticket numbers to winning ticket numbers. A point of sale system is not a gaming server.

A gaming server is a server used by game clients to play video games, whether single player games or multi-player games.

A purchaser is one who purchases. In the present invention, the purchaser specifically is one who purchases a lottery ticket or tickets using the web-based application or the mobile application. Here, purchaser and ticker purchaser are used interchangeably.

A database or software application is said to reside within or without a facility when it is situated within or outside of the facility respectively. Having contact with an application means the ability to directly read from or write to the application, without any intermediate software.

Virtually scratching off an electronic skin means clicking on the skin or rubbing on it, such that the skin disappears to reveal whatever is concealed underneath it.

### DESCRIPTION OF THE PREFERRED EMBODIMENT AND BEST MODE

As shown in the figures, the preferred embodiment and best mode of the present invention comprises:

A user interface for purchasing and redeeming lottery tickets to enable remote purchase and remote redemption of lottery tickets by a purchaser, comprising a web browser and one or more web-based software applications for purchasing and redeeming lottery tickets and a point of sale computer system, wherein lottery ticket numbers are displayed in the web browser, wherein a ticket purchaser uses the web browser and a communications link to access software applications residing on a lottery vending service providers web server, wherein the lottery vending service provider's software applications and web server and point of sale computer system have no access to any software applications or databases residing within a lottery facility, wherein the lottery vending service providers software applications and web server and point of sale computer system are not gaming servers, wherein the lottery facility has only write-only access to a winning lottery numbers database which database resides outside of the lottery facility, wherein the lottery vending service providers web server and software applications and point of sale computer system have only read-only access to the winning lottery numbers database, wherein the lottery vending service providers web server and software applications have only write-only access to a purchased lottery numbers database which database resides outside of the lottery facility, wherein the lottery facility has only read-only access to the purchased lottery numbers database.

The embodiments of the invention may also comprise the preceding user interface, wherein the communications link is an Internet link or a wireless mobile phone link.

The embodiments of the invention may also comprise the preceding user interface, wherein the web browser is stored in a memory on a desktop computer.

The embodiments of the invention may also comprise the preceding user interface, wherein the web browser is stored in a memory on a mobile device.

The embodiments of the invention may also comprise the preceding user interface, wherein the mobile device is at least one of the following: a cellular phone, a smartphone, a notebook computer, a netbook computer, or a personal digital assistant.

The embodiments of the invention may also comprise the preceding user interface, wherein the application enables a purchaser to purchase a lottery ticket or tickets automatically at a date and time certain.

The embodiments of the invention may also comprise the preceding user interface, wherein the application enables a purchaser to purchase a lottery ticket or tickets automatically on a scheduled basis.

The embodiments of the invention may also comprise the preceding user interface, wherein the application can be programmed by a purchaser to alert the purchaser regarding when specified jackpot amounts have been reported by the lottery facility.

The embodiments of the invention may also comprise the preceding user interface, wherein the lottery ticket is for a scratch-off type lottery game, wherein the lottery ticket numbers displayed in the web browser are initially covered with electronic skins that the purchaser virtually scratches off.

The embodiments of the invention also comprise a user interface for purchasing and redeeming lottery tickets to enable remote purchase and remote redemption of lottery tickets by a purchaser, comprising a mobile application for purchasing and redeeming lottery tickets, wherein a ticket purchaser uses the mobile application to access a lottery vending service provider's point of sale computer system, wherein lottery ticket numbers are displayed by the mobile application, wherein the lottery vending service providers point of sale computer system has no access to any software applications or databases residing within a lottery facility, wherein the lottery vending service providers point of sale computer system is not a gaming server, wherein the lottery facility has only write-only access to a winning lottery numbers database which database resides outside of the lottery facility, wherein the lottery vending service provider's point of sale computer system has only read-only access to the winning lottery numbers database, wherein the lottery vending service providers point of sale computer system has only write-only access to a purchased lottery numbers database which database resides outside of the lottery facility, wherein the lottery facility has only read-only access to the purchased lottery numbers database.

The embodiments of the invention may also comprise the preceding user interface, wherein the communications link is a wireless mobile phone link.

The embodiments of the invention may also comprise the preceding user interface, wherein the mobile application is stored in a memory on a mobile device.

The embodiments of the invention may also comprise the preceding user interface, wherein the mobile device is at least one of the following: a cellular phone, a smartphone, a notebook computer, a netbook computer, or a personal digital assistant.

The embodiments of the invention may also comprise the preceding user interface, wherein the application enables a purchaser to purchase a lottery ticket or tickets automatically at a date and time certain.

The embodiments of the invention may also comprise the preceding user interface, wherein the application enables a purchaser to purchase a lottery ticket or tickets automatically on a scheduled basis.

The embodiments of the invention may also comprise the preceding user interface, wherein the application can be programmed by a purchaser to alert the purchaser regarding when specified jackpot amounts have been reported by the lottery facility.

The embodiments of the invention may also comprise the preceding user interface, wherein the lottery ticket is for a scratch-off type lottery game, wherein the lottery ticket numbers displayed by the mobile application are initially covered with electronic skins that the purchaser virtually scratches off.

The embodiments of the invention also comprise a lottery ticket purchase and redemption system comprising a computer having a computer memory, and a web server having a web server memory, wherein the computer memory includes a web browser, wherein the web server memory includes software applications and a point of sale computer system, wherein the software applications provide an ability to remotely purchase and remotely redeem lottery tickets from the point of sale computer system through the web browser, wherein the system does not include a gaming server.

The embodiments of the invention also comprise a lottery ticket purchase and redemption system comprising a mobile device having a mobile device memory, and a web server having a web server memory, wherein the mobile device memory includes a web browser, wherein the web server memory includes software applications and a point of sale computer system, wherein the software applications provide an ability to remotely purchase and remotely redeem lottery tickets from the point of sale computer system through the web browser, wherein the system does not include a gaming server.

The embodiments of the invention may also comprise the preceding system, wherein the mobile device is at least one of the following: a cellular phone, a smartphone, a notebook computer, a netbook computer, or a personal digital assistant.

The embodiments of the invention also comprise a lottery ticket purchase and redemption system comprising a mobile device having a mobile device memory and a point of sale computer system, wherein the mobile device memory includes a mobile application for remotely purchasing and redeeming lottery tickets from the point of sale computer system, wherein the system does not include a gaming server.

The embodiments of the invention may also comprise the preceding system, wherein the mobile device is at least one of the following: a cellular phone, a smartphone, a notebook computer, a netbook computer, or a personal digital assistant.

The embodiments of the invention also comprise a method for selling lottery tickets, comprising: displaying, on a display screen of a computer, a web browser-based application for purchasing lottery tickets, wherein the web browser-based application accesses a point of sale computer system, wherein the point of sale computer system does not have contact with any software applications that determine or write winning lottery numbers, wherein the point of sale computer system is not a gaming server.

The embodiments of the invention also comprise a method for selling lottery tickets, comprising: displaying, on a display screen of a mobile device, a web browser-based application for purchasing lottery tickets, wherein the web browser-based application accesses a point of sale computer system, wherein the point of sale computer system does not have contact with any software applications that determine or write winning lottery numbers, wherein the point of sale computer system is not a gaming server.

The embodiments of the invention also comprise a method for selling lottery tickets, comprising: displaying, on a display screen of a mobile device, a mobile application for purchasing lottery tickets, wherein the mobile application accesses a point of sale computer system, wherein the point of sale computer system does not have contact with any software applications that determine or write winning lottery numbers, wherein the point of sale computer system is not a gaming server.

Some advantages of the embodiments of the apparatus were previously enumerated in the Summary section. Every advantageous feature does not need to be incorporated into every embodiment of the apparatus and/or methods.

Although these versions of the invention have been described in considerable detail, other versions are possible. For example, embodiments can comprise combinations of the features described herein, such as combinations of the dependent claims. Therefore, the spirit and scope of the appended claims should not be limited to the description of the versions contained therein.

We claim:

1. A user interface for purchasing and redeeming lottery tickets to enable remote purchase and remote redemption of lottery tickets by a purchaser, comprising a web browser and one or more web-based software applications for purchasing and redeeming lottery tickets and a point of sale computer system, wherein lottery ticket numbers are displayed in the web browser, wherein a ticket purchaser uses the web browser and a communications link to access software applications residing on a lottery vending service providers web server, wherein the lottery vending service providers software applications and web server and point of sale computer system have no access to any software applications or databases residing within a lottery facility, wherein the lottery vending service providers software applications and web server and point of sale computer system are not gaming servers, wherein the lottery facility has only write-only access to a winning lottery numbers database which database resides outside of the lottery facility, wherein the lottery vending service providers web server and software applications and point of sale computer system have only read-only access to the winning lottery numbers database, wherein the lottery vending service providers web server and software applications have only write-only access to a purchased lottery numbers database which database resides outside of the lottery facility, wherein the lottery facility has only read-only access to the purchased lottery numbers database.

2. The user interface of claim 1, wherein the communications link is an Internet link.

3. The user interface of claim 1, wherein the communications link is a wireless mobile phone link.

4. The user interface of claim 1, wherein the web browser is stored in a memory on a desktop computer.

5. The user interface of claim 1, wherein the web browser is stored in a memory on a mobile device.

6. The user interface of claim 5, wherein the mobile device is at least one of the following: a cellular phone, a smartphone, a notebook computer, a netbook computer, or a personal digital assistant.

7. The user interface of claim 1, wherein the application enables a purchaser to purchase a lottery ticket or tickets automatically at a date and time certain.

8. The user interface of claim 1, wherein the application enables a purchaser to purchase a lottery ticket or tickets automatically on a scheduled basis.

9. The user interface of claim 1, wherein the application can be programmed by a purchaser to alert the purchaser regarding when specified jackpot amounts have been reported by the lottery facility.

10. The user interface of claim 1, wherein the lottery ticket is for a scratch-off type lottery game, wherein the lottery ticket numbers displayed in the web browser are initially covered with electronic skins that the purchaser virtually scratches off.

11. A user interface for purchasing and redeeming lottery tickets to enable remote purchase and remote redemption of lottery tickets by a purchaser, comprising a mobile application for purchasing and redeeming lottery tickets, wherein a ticket purchaser uses the mobile application to access a lottery vending service providers point of sale computer system, wherein lottery ticket numbers are displayed by the mobile application, wherein the lottery vending service providers point of sale computer system has no access to any software applications or databases residing within a lottery facility, wherein the lottery vending service provider's point of sale computer system is not a gaming server, wherein the lottery facility has only write-only access to a winning lottery numbers database which database resides outside of the lottery facility, wherein the lottery vending service providers point of sale computer system has only read-only access to the winning lottery numbers database, wherein the lottery vending service provider's point of sale computer system has only write-only access to a purchased lottery numbers database which database resides outside of the lottery facility, wherein the lottery facility has only read-only access to the purchased lottery numbers database.

12. The user interface of claim 11, wherein the communications link is a wireless mobile phone link.

13. The user interface of claim 11, wherein the mobile application is stored in a memory on a mobile device.

14. The user interface of claim 13, wherein the mobile device is at least one of the following: a cellular phone, a smartphone, a notebook computer, a netbook computer, or a personal digital assistant.

15. The user interface of claim 11, wherein the application enables a purchaser to purchase a lottery ticket or tickets automatically at a date and time certain.

16. The user interface of claim 11, wherein the application enables a purchaser to purchase a lottery ticket or tickets automatically on a scheduled basis.

17. The user interface of claim 11, wherein the application can be programmed by a purchaser to alert the purchaser regarding when specified jackpot amounts have been reported by the lottery facility.

18. The user interface of claim 11, wherein the lottery ticket is for a scratch-off type lottery game, wherein the lottery ticket numbers displayed by the mobile application are initially covered with electronic skins that the purchaser virtually scratches off.

19. (canceled)

20. (canceled)

21. (canceled)

22. (canceled)

23. (canceled)

24. (canceled)

25. (canceled)

26. (canceled)
